(19) United States
(12) Patent Application Publication
(10) Pub. No.: US 2016/0018661 A1
(43) Pub. Date: Jan. 21, 2016

(54) ORNAMENTAL DISPLAY

(71) Applicant: MINOSHOJI CO., LTD., Kyoto-shi (JP)

(72) Inventors: Takeshi OTSUBO, Kyoto (JP); Hiroshi UCHIMOTO, Kyoto (JP)

(21) Appl. No.: 14/123,902

(22) PCT Filed: Apr. 15, 2013
(86) PCT No.: PCT/JP2013/061212

§ 371 Date: Dec. 4, 2013

(30) Foreign Application Priority Data
Jul. 10, 2012 (JP) 2012-154233

(51) Int. Cl. G02B 27/22; G02B 5/20; G02B 3/00

(52) U.S. Cl. CPC G02B 27/2214; G02B 3/0056; G02B 5/20

(57) ABSTRACT

An ornamental display 1 includes a plate-like transparent material 11 having a surface on which a light collecting element pattern 111 is formed, wherein the light collecting element pattern 111 is formed by a plurality of convex lens-shaped light collecting elements 111a arranged two-dimensionally at a predetermined array pitch p with a directional arrangement, and a non-transparent sheet-like through-hole filter 12 having a through-hole pattern formed by a plurality of through-holes 121a arranged two-dimensionally with the same directional arrangement 121 as the directional arrangement of the light collecting element pattern 111 at an array pitch q. In this ornamental display, the transparent material 111 and the through-hole filter 121 are arranged in a manner such that the light collecting element pattern 111 and the through-hole pattern 121 face each other with a predetermined distance d therebetween.

### TECHNICAL FIELD

The present invention relates to an ornamental display for use in ornamentation of various products, such as, e.g., outer layer panels for amusement machines and/or gaming machines, packaging boxes, advertising media, ornaments, displaying devices, stationeries, souvenirs, structures, teaching materials, etc.

### TECHNICAL BACKGROUND

Conventionally, to ornament various products, such as, e.g., outer layer panels for amusement machines and/or gaming machines, packaging boxes, advertising media, ornaments, displaying devices, stationeries, souvenirs, structures, and teaching materials, it is known to apply an ornamental display in which an enlarged virtual image of a pattern is made to appear above or below a surface of various products. Such ornamental displays are disclosed, for example, in Patent Documents 1 to 5 listed below.

In these ornamental displays, a light collecting element pattern is formed on a surface of a sheet-like or plate-like transparent material by two-dimensionally arranging a plurality of convex lens-shaped light collecting elements at a predetermined array pitch with a directional arrangement. Further, an image element pattern is formed on the back surface of the transparent material by two-dimensionally forming a plurality of colored image elements with the same directional arrangement as the directional arrangement of the light collecting element pattern at an array pitch different from the array pitch of the light collecting elements. The light collecting element pattern and the image element pattern are formed such that the array pitch of the light collecting elements and the array pitch of the image elements are differentiated, thereby making it possible to make an enlarged virtual image of a three-dimensional pattern by the image element pattern appear.

### PRIOR ART DOCUMENTS

### Patent Document

Patent Document 1: Japanese Patent No. 4907049 (JP 4907049, B)

Patent Document 2: Japanese Patent No. 3488179 (JP 3488179, B)

Patent Document 3: Japanese Unexamined Laid-open Patent Application Publication No. 2008-012870 (JP 2008-012870, A)

Patent Document 4: Japanese Unexamined Laid-open Patent Application Publication No. 2003-226100 (JP 2003-226100, A)

Patent Document 5: Japanese Unexamined Laid-open Patent Application Publication No. 2003-226099 (JP 2003-226099, A)

### DISCLOSURE OF THE INVENTION

### Problems to be Solved by the Invention

However, in conventional ornamental displays, an image element pattern is formed only by printing, and there exist no ornamental display having an image element pattern formed by other methods.

The present invention was made in view of the aforementioned technical background, and aims to provide a highly interesting ornamental display capable of making an enlarged virtual image of image elements appear based on an image element pattern having a new configuration.

### Means for Solving the Problems

To achieve the aforementioned object, the present invention includes a sheet-like or plate-like transparent material having a surface on which a light collecting element pattern is formed, wherein the light collecting element pattern is formed by a plurality of convex lens-shaped light collecting elements arranged two-dimensionally at a predetermined array pitch with a directional arrangement, and a through-hole filter made of a sheet-like or plate-like light blocking material having a through-hole pattern, wherein the through-hole pattern is formed by a plurality of through-holes arranged two-dimensionally with the same directional arrangement as the directional arrangement of the light collecting element pattern at an array pitch different from the array pitch of the light collecting elements, wherein the transparent material and the through-hole filter are arranged in a manner such that the light collecting element pattern and the through-hole pattern face each other with a predetermined distance therebetween.

According to this, when an arbitrary light, such as, natural light, artificial light, etc., is irradiated against the through-hole filter, the light enters each of the through-holes of the through-hole pattern to pass through each of the through-holes, forming a light image element. Thus, a light image element pattern is formed by the light image elements. This light image element pattern constitutes the same pattern as the through-hole pattern. The light image elements are arranged two-dimensionally with the same directional arrangement as the directional arrangement of the light collecting element pattern at an array pitch different from the array pitch of the light collecting elements. Therefore, an overlapping portion in which the light image element and the light collecting element overlap and a displaced portion in which the light image element and the light collecting element are displaced repeatedly occur, which makes it possible to appear a three-dimensional enlarged virtual image of the light image elements on the front side or the back side of the transparent material in a static state with less instability without being limited in positions from which they can be seen.

It is preferable that the through-hole filter is set to 30% or less in light transmission rate of the light blocking material. According to this, although light passes through the through-holes of the through-hole filter as it is, only 30% or less of the light passes through the portion of the light blocking material other than the through-holes. This increases the contrast of brightness between the light image elements passed through the through-holes and the peripheral portion of the light image elements, thereby making it possible to clearly form the light image elements.

It is preferable that the through-hole filter is adhered to the back surface of the transparent material. According to this, the through-hole filter is fixed to the transparent material, and therefore the light collecting element pattern and the through-hole pattern can stably face each other, which makes it possible to easily and assuredly make an enlarged virtual image of the light image elements appear.

Further, the through-hole filter can be adhered to a front surface or a back surface of a second transparent material arranged to face the transparent material with a predetermined distance therefrom. According to this, even when the through-hole filter is arranged so as to be separated from the transparent material having the light collecting elements, since it is adhered to the front surface or the back surface of the second transparent material, the through-hole filter 12 can be prevented from causing deformations such as bending.

It is preferable that a transparent color filter colored with a predetermined color is arranged so as to face the through-hole filter. According to this, since light image elements are colored by the light passed through the color filter before or after passing through the through-holes of the through-hole filter, an enlarged virtual image of the light image element can be colored with a desired color.

It is preferable that a light irradiation device for irradiating artificial light against the through-hole filter is provided. According to this, it becomes possible to make an enlarged virtual image of the light image elements clearly appear by strengthening the illumination of the artificial light. In addition, the enlarged virtual image of the light image elements can be arbitrarily made to appear or disappear by turning on or off the artificial light of the light irradiation device.

### Effect of the Invention

According to the present invention, when arbitrary light, such as, natural light, artificial light, etc., is irradiated against the through-hole filter, the light enters the through-holes of the through-hole pattern, resulting in light image elements by passing through the through-holes, which in turn forms a light image element pattern. The light image element pattern has the same pattern as the through-hole pattern, wherein the light image elements are two-dimensionally arranged with the same directional arrangement as the directional arrangement of the light collecting element pattern at an array pitch different from the array pitch of the light collecting elements. Therefore, an overlapping portion in which the light image element and the light collecting element overlap and a displaced portion in which the light image element and the light collecting element are displaced repeatedly occur, which makes it possible to make a three-dimensional enlarged virtual image of the light image elements appear on the front side or the back side of the transparent material in a static state with little instability without being limited in positions from which they can be seen. Therefore, more interesting ornamental effects can be exerted as compared with the case in which enlarged virtual images of image elements simply printed in a conventional manner are made to appear.

### BRIEF DESCRIPTION OF THE DRAWINGS

FIG. 1 is a front view of an ornamental display according to a first embodiment of the present invention.

FIG. 2 is a rear view of the ornamental display of FIG. 1.

FIG. 3 is a cross-sectional view of the ornamental display of FIG. 1.

FIG. 4 is an enlarged cross-sectional view of the ornamental display of FIG. 1.

FIG. 5 is a front schematic view showing the positional relationship of the light collecting elements and the through-holes of the ornamental display of FIG. 1.

FIG. 6 is a view showing a cross-section of the ornamental display of FIG. 1 and an enlarged virtual image.

FIG. 7 is an enlarged cross-sectional view of an ornamental display according to a second embodiment.

FIG. 8 is a front schematic view showing the positional relationship of the light collecting elements and the through-holes of the ornamental display of FIG. 7.

FIG. 9 is a view showing a cross-section of the ornamental display of FIG. 7 and an enlarged virtual image.

FIG. 10 is an enlarged cross-sectional view of an ornamental display according to a third embodiment.

FIG. 11(a) is a front view showing the ornamental display of FIG. 10 before irradiation and FIG. 11(b) is a front view showing the ornamental display of FIG. 10 after irradiation.

FIG. 12 is an enlarged cross-sectional view of an ornamental display according to a fourth embodiment.

FIG. 13 is an enlarged cross-sectional view of an ornamental display according to a fifth embodiment.

### EMBODIMENTS FOR CARRYING OUT THE INVENTION

### First Embodiment

Next, a first embodiment of an ornamental display according to the present invention will be explained with reference to the attached FIGS. 1 to 6.

The ornamental display 1 of this embodiment includes, as shown in FIGS. 1 to 3, a plate-like transparent material 11 made of synthetic resin such as an acrylic board, and a through-hole filter 12 arranged on the back surface side of the transparent material 11. The ornamental display 1 is provided with a light irradiation device 15 for irradiating artificial light against the through-hole filter 12 from the through-hole filter 12 side.

As shown in FIG. 1, the transparent material 11 has a surface on which a light collecting element pattern 111 is formed on the entirety thereof. The light collecting element pattern is formed by a plurality of lens-shaped light collecting elements 111a printed using colorless transparent ink.

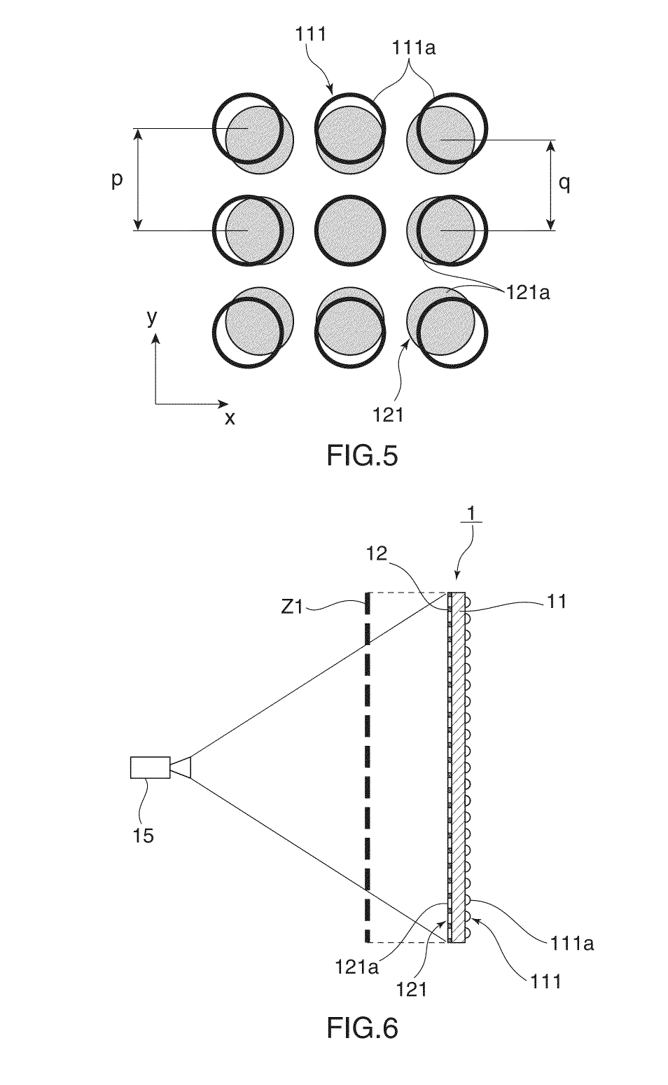

The light collecting element pattern 111, as shown in FIG. 5, has light collecting elements 111a arranged two-dimensionally with a directional arrangement. The light collecting elements 111a are equally arranged in a matrix form at the same array pitch p in a x-direction and a y-direction perpendicular to the x-direction.

In this embodiment, the diameter of each light collecting element 111a is set to 0.9 mm and the array pitch p is set to 1.0 mm. The arrangement of the light collecting elements 111a is not always required be an orthogonal pattern and can be an arrangement in which the arrangement direction with respect to the other arrangement direction can be an angle smaller than 90 degrees or an angle larger than 90 degrees.

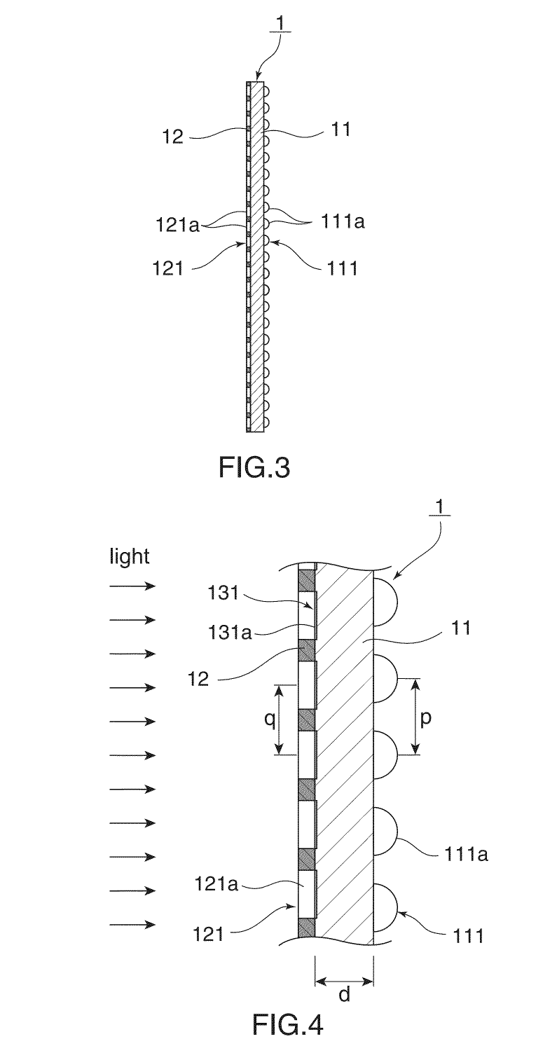

The transparent material 11 is formed to have a predetermined thickness d as shown in FIG. 4. The thickness d is set as a distance in which an enlarged virtual image Z1 is made to appear by the below-mentioned light image element 131a by using the light collecting element 111a of the light collecting element pattern 111 formed on the surface of the transparent material 11. Further, the thickness d is arbitrarily set according to the sizes and the array pitches of the light collecting elements 111a and the light image elements 131a. In this embodiment, the thickness d of the transparent material 11 is set to 2.0 mm.

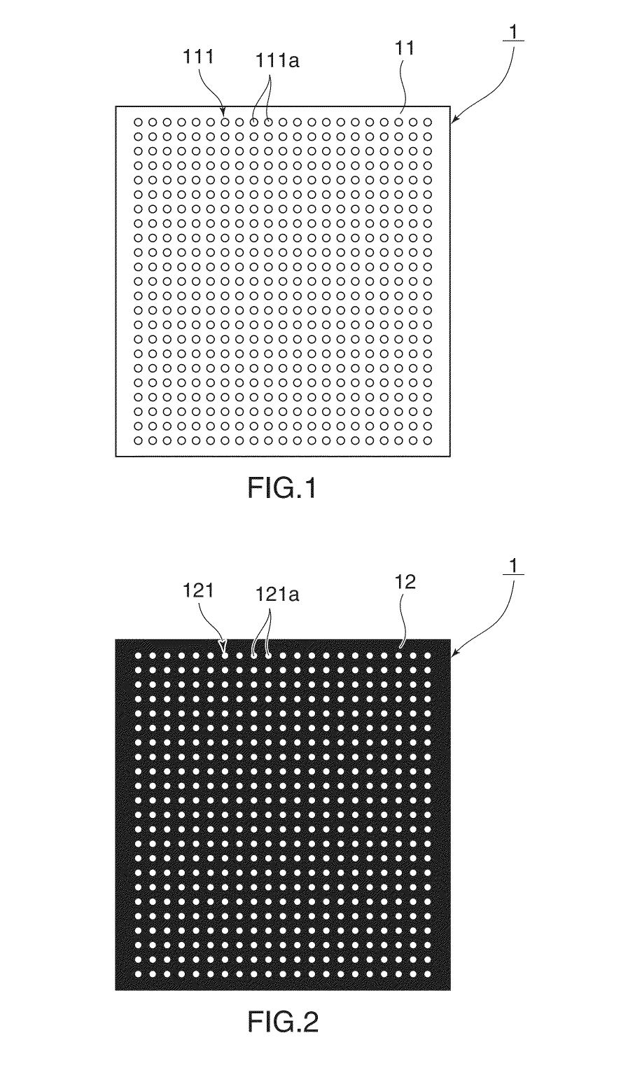

The through-hole filter 12 is a sheet-like light blocking material made of synthetic resin and is adhered to the back surface of the transparent material 11 via an adhesive agent layer (not illustrated), as shown in FIGS. 2 to 4. The through-hole filter 12 includes a plurality of through-holes 121a formed in the entirety thereof, and a through-hole pattern 121 is formed by the plurality of through-holes 121a. In this embodiment, the diameter of the through-hole 121a is set to 0.9 mm.

The through-hole pattern 121 has, as shown in FIG. 5, a plurality of through-holes 121a arranged two-dimensionally with the same directional arrangement as the directional arrangement of the light collecting element pattern 111. The through-holes 121a are equally arranged in a matrix form in a x-direction and a y-direction perpendicular to the x-direction.

In the through-hole pattern 121, the through-holes 121a are arranged at an array pitch q smaller than the array pitch p of the light collecting elements 111a, as shown in FIG. 4 and FIG. 5. In this embodiment, the array pitch q of the through-holes 121a is set to 0.95 mm.

Therefore, in each direction of the x-y plane, for every plural number of light collecting elements 111a and through-holes 121a, the portion where the light collecting elements 111a and the through-holes 121a completely overlap and the portion where the through-holes 121a in the periphery of the overlapped portions sequentially and inwardly get displaced from the light collecting element 111a repeatedly occur.

The through-hole filter 12 is set to 0% in light transmission rate of the light blocking material. Here, the light transmission rate denotes a ratio of light (luminous existence) passing through the light blocking material of the through-hole filter 12, not including the through-holes 121a. According to this, when light is irradiated against the through-hole filter 12, light passes through the through-holes 121a, thereby forming the below-mentioned light image elements 131a. However, since light does not pass through the light blocking material, the contrast of brightness between the light image elements 131a and the periphery of the light image elements 131a becomes extremely large, making it possible to clearly form the light image elements 131a.

The light irradiation device 15 is arranged with a predetermined distance from the surface of the through-hole filter 12 and irradiates light (artificial light) against the surface of the through-hole filter 12. The light irradiation device 15 is set so as to irradiate light approximately orthogonally against the entire surface of the through-hole filter 12. In addition, the light irradiation device 15 is set to irradiate light that is brighter than at least the peripheral environment (for example, natural light), and therefore, clear light image elements 131a can be formed by light passing through the through-holes 121a. The light irradiation device 15 is provided with a switch that is not illustrated in the drawings, and light can be turned on and off by turning the switch ON/OFF.

As shown in FIG. 6, when light is irradiated from the through-hole filter 12 side using the light irradiation device 15, light enters the through-holes 121a that form the through-hole pattern 121. Then, the light passes through to the transparent material 11 side, thereby forming the light image elements 131a at the periphery of the exits of the through-holes 121a, and the light image elements 131a form a light image element pattern 131. The light image element pattern 131 has the same pattern as the through-hole pattern 121. The light image elements 131a are two-dimensionally arranged with the same directional arrangement as the directional arrangement of the light collecting element pattern 111 at an array pitch q different from the array pitch p of the light collecting elements 111a. Therefore, in each direction of the x-y plane, since an overlapping portion in which the light image element 131a and the light collecting element 111a overlap and a displaced portion in which the light image element 131a and the light collecting element 111a are displaced repeatedly occur, it is possible to make a three-dimensional enlarged virtual image of the light image elements 131a appear in a static state with less instability without being limited in positions from which they can be seen.

In this embodiment, since the array pitch q of the through-holes 121a (light image elements 131a) is set to be smaller than the array pitch p of the light collecting elements 111a, the enlarged virtual image Z1 of the light image element 131a appears on the back side of the transparent material 11 (opposite side of the light collecting elements 111a of the transparent material 11).

According to the aforementioned ornamental display 1, it becomes possible to make an enlarged virtual image Z1 of the light image elements 131a appear based on the light image element pattern 131 having a new structure formed using light.

Since the through-hole filter 12 is adhered to the back surface of the transparent material 11, the through-hole filter 12 is fixed to the transparent material 11 such that the light collecting element pattern 111 and the through-hole pattern 121 stably face each other. Therefore, it becomes possible to make an enlarged virtual image Z1 of the light image elements 131a appear easily and assuredly.

Further, it is also possible to make the enlarged virtual image Z1 of the light image elements 131a appear more clearly by strengthening the illumination of the artificial light of the light irradiation device 15. Also, by turning on and off the artificial light of the light irradiation device 15, it is possible to arbitrarily make the enlarged virtual image Z1 of the light image elements 131a appear and disappear.

### Second Embodiment

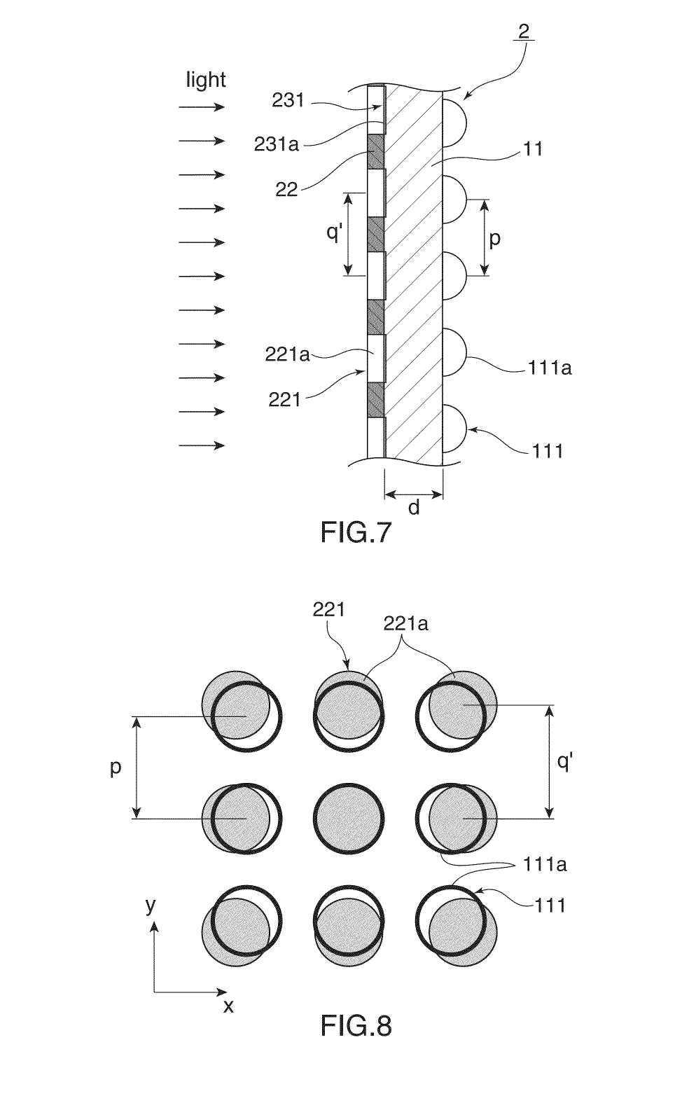

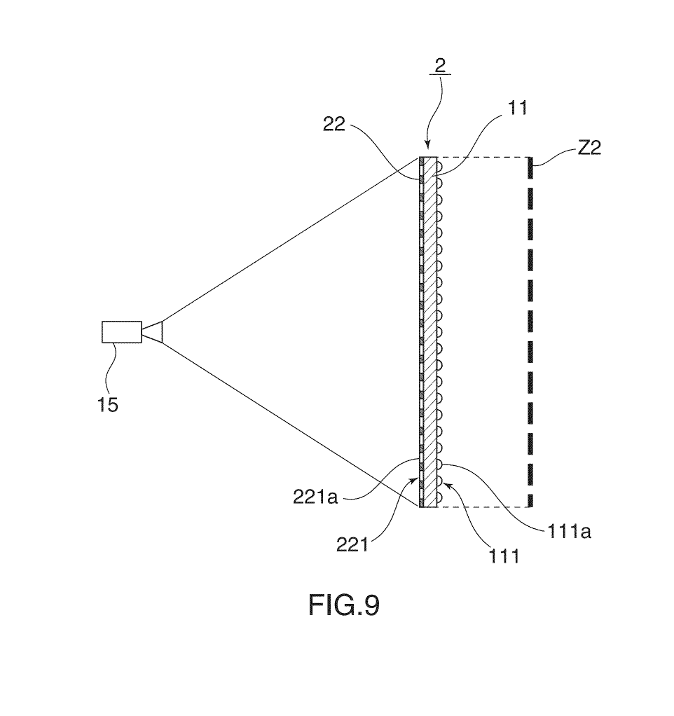

Next, a second embodiment of an ornamental display according to the present invention will be explained with reference to FIGS. 7 to 9. Hereinafter, only the structures that differ from the aforementioned embodiment will be explained, and duplicate explanations will be omitted by allotting the same symbols to the same structures.

In the ornamental display 2 of this embodiment, in the through-hole filter 22, as shown in FIG. 7, through-holes 221a forming a through-hole pattern 221 are arranged at an array pitch q′ larger than the array pitch p of the light collecting elements 111a. The array pitch q′ of the through-holes 221a is set to 1.05 mm. Therefore, as shown in FIG. 8, in each direction of the x-y plane, for every plural number of light collecting elements 111a and through-holes 221a, a portion where the light collecting elements 111a and the through-holes 221a completely overlap and a portion where the through-holes 221a in the periphery of the overlapped portion sequentially and inwardly get displaced from the light collecting elements 111a repeatedly occur.

When light is irradiated from the through-hole filter 22 side using the light irradiation device 15, a light image element 231a is formed for each through-hole 221a, as shown in FIG. 7. Thus, since a light image element pattern 231 is formed by the light image elements 231a, it is possible to make a three-dimensional enlarged virtual image Z2 of the light image elements 231a appear in a static state with less instability without being limited in positions from which they can be seen. In this embodiment, because the array pitch q′ of the through-holes 221a (light image elements 231a) is set to be larger than the array pitch p of the light collecting elements 111a, it is possible to make the enlarged virtual image Z2 of the light image elements 231a appear on the front side of the transparent material 11 (light collecting element 111a side of the transparent material 11).

### Third Embodiment

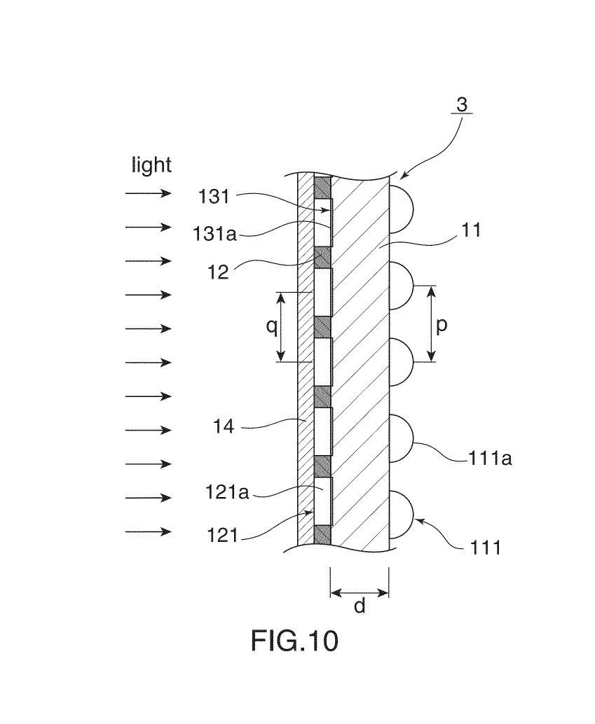

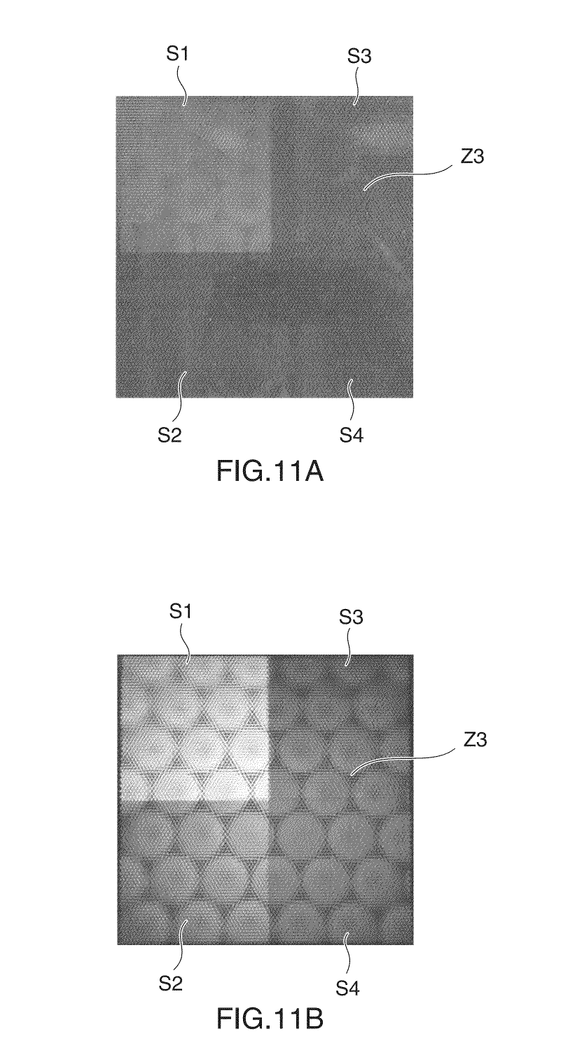

Next, a third embodiment of an ornamental display according to the present invention will be explained with reference to FIGS. 10 and 11.

In the ornamental display 3 of this embodiment, a sheet-like transparent color filter 14 is adhered to the surface of the through-hole filter 12, as shown in FIG. 10. The color filter 14 is divided into 2×2 lengthwise and widthwise regions S1 to S4, wherein the region S1 is colorless, the region S2 is green, the region S3 is blue, and the region S4 is red, as shown in FIG. 11.

According to the ornamental display 3, since light that passes through the color filter 14 is colored and becomes light image elements 131a, an enlarged virtual image Z3 of the light image elements 131a can be colored in accordance with each of the regions, wherein the region S1 is colorless, the region S2 is green, the region S3 is blue, and the region S4 is red.

For example, as shown in FIG. 11 (a), since the brightness of the enlarged virtual image Z3 of the light image elements 131a is low before irradiating artificial light using the light irradiation device 15, the enlarged virtual image Z3 of the light image elements 131a does not nearly appear (it barely appears by natural light). On the other hand, as shown in FIG. 11 (b), the enlarged virtual image Z3 of the light image elements 131a clearly appears since the brightness of the enlarged virtual image Z3 of the light image elements 131a improves after irradiating artificial light using the light irradiation device 15. Furthermore, since the enlarged virtual image Z3 of the light image elements 131a is colored by the color filter 14, it is possible to vividly display each color of the enlarged virtual image Z3 of the light image elements 131a.

In this embodiment, the explanation was directed to the case in which the color filter 14 is divided into 2×2 lengthwise and widthwise regions S1 to S4, but the number of the divisions, the shape, the size, and the color of the regions can be arbitrarily set.

The color filter 14 can be arranged with a predetermined distance from the through-hole filter 12.

### Fourth Embodiment

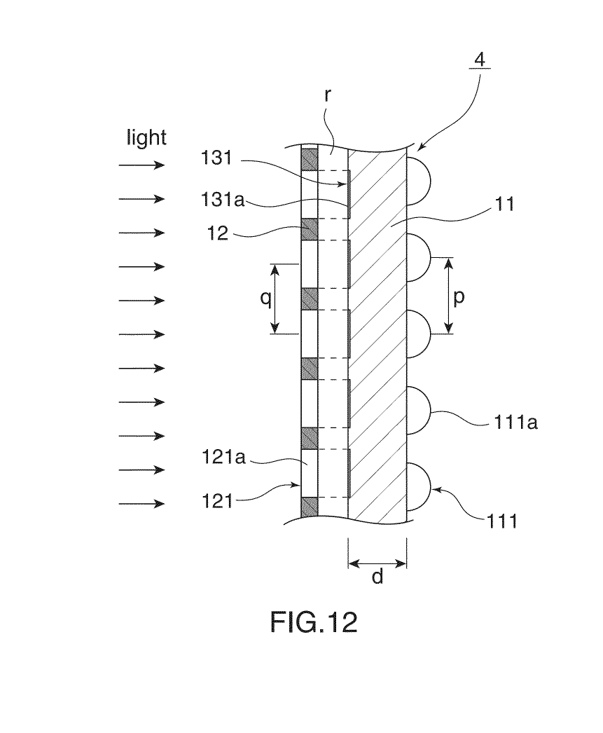

Next, a fourth embodiment of an ornamental display according to the present invention will be explained with reference to FIG. 12.

In the ornamental display 4 of this embodiment, as shown in FIG. 12, the through-hole filter 12 is arranged so as to face the back surface of the transparent 11 having thickness d in a parallel manner with a predetermined distance r therebetween.

In this manner, even when the transparent material 11 and the through-hole filter 12 are arranged with a predetermined distance r therebetween, light that entered the through-holes 121a of the through-hole filter 12 passes through to the transparent material 11 side, becoming light image elements 131a and thereby forming a light image element pattern 131 of the light image elements 131a. Therefore, it is possible to make a three-dimensional enlarged virtual image of the light image elements 131a appear in a static state with less instability without being limited in positions from which they can be seen.

### Fifth Embodiment

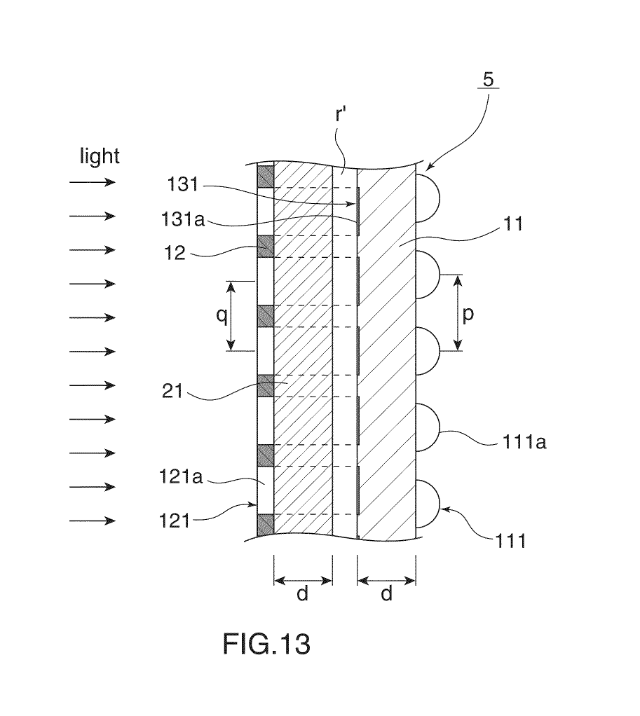

Next, a fifth embodiment of an ornamental display according to the present invention will be explained with reference to FIG. 13.

In the ornamental display 5 of this embodiment, as shown in FIG. 13, a second transparent material 21 having a thickness d, having both faces that are flatly formed, is arranged on the back surface side of the transparent material 11 with a predetermined distance r′. The through-hole filter 12 is adhered to the back surface of the second transparent material 21.

In this manner, even when the transparent material 11 and the through-hole filter 12 are arranged with a predetermined distance r′ while interposing the transparent material 21 therebetween, light that enters the through-holes 121a of the through-hole filter 12 passes through to the transparent material 11 side, becoming light image elements 131a and thereby forming a light image element pattern 131 of the light image elements 131a. Therefore, it is possible to make a three-dimensional enlarged virtual image of the light image elements 131a appear in a static state with less instability without being limited in positions from which they can be seen. Furthermore, since the through-hole filter 12 is adhered to the transparent material 21, the through-hole filter 12 can be prevented from being deformed, such as bending.

In this embodiment, the explanation was directed to the case in which the through-hole filter 12 is adhered to the surface of the transparent material 21 (left side surface of FIG. 13), but it can be adhered to the front surface of the transparent material 21 (right side surface of FIG. 13).

Further, the explanation was directed to the case in which the thickness of the transparent material 21 is the same as the thickness d of the transparent material 11, but the thicknesses are not required to be the same.

In each of the aforementioned embodiments, the through-hole filters 12 and 22 were described to be sheet-like, but they can be plate-like.

Also, a case in which the transparent material 11 is plate-like was described, but it can be sheet-like.

Also, the explanation was directed to the case in which a light blocking material 0% in light transmission rate is used as a through-hole filter 12, but a light blocking material with light transmission rate exceeding 0% can be used. However, to increase the brightness contrast between light image elements 131a and 231a formed by passing through the through-holes 121a and 221a of the through-hole filter 12 and the periphery of the light image elements 131a and 231a, it is preferable that the through-hole filter 12 is set to 30% or less, preferably 20% or less, even more preferably 10% or less, in light transmission rate of the light blocking material.

The light collecting elements 111a and the through-holes 121a and 221a (light image elements 131a and 231a) were described to be circular, but they can be other shapes.

Further, the light collecting elements 111a were described to be formed by printing, but they can be formed by other methods such as embossing.

Furthermore, the explanation was directed to the case in which the array pitch p of the light collecting elements 111a is 1.0 mm, the array pitch q of the through-holes 121a and 221a (light image elements 131a and 231a) is 0.95 mm, and the array pitch q′ is 1.05 mm, but any other array pitches can be set. However, to assuredly make an enlarged virtual image of the light image elements appear, it is preferable that the array pitch of the light collecting elements is within a range of 0.30 to 2.0 mm, the array pitch of the through-holes is within a range of 0.20 to 2.2 mm, and the difference in the array pitches of the light collecting elements and the through-holes is set to be within a range of about ±20%.

Also, the explanation was directed to the case in which the array pitch p of the light collecting elements 111a and the array pitches q and q′ of the through-holes 121a and 221a (light image elements 131a and 231a) are uniform, but the array pitches can be configured to change, and it can also be configured such that one of the array pitches is uniform and the other of the array pitches changes.

Further, the explanation was directed to the case in which the diameter of the light collecting elements 111a and the through-holes 121a and 221a (light image elements 131a and 231a) is set to be 1.0 mm, but the diameter can be any diameter. However, to assuredly make the enlarged virtual image of the light image elements appear, it is preferable that the diameter of the light collecting elements and the through-holes is set to be within a range of 0.10 to 2.5 mm.

Further, the explanation was directed to the case in which the diameter of the light collecting elements 111a and the diameter of the through-holes 121a and 221a (light image elements 131a and 231a) are the same, but the diameter is not required to be the same.

Furthermore, the explanation was directed to the case in which the thickness of the transparent material 11 is set to be 2.0 mm, but the thickness is not required to be 2.0 mm. The thickness d of the transparent material 11 is arbitrarily set by the size and the array pitches of the light collecting elements 111a and the through-holes 121a and 221a (light image elements 131a and 231a). For example, when the diameters of the image elements of the light collecting element 111a and through-holes 121a and 221a (light image elements 131a and 231a) are set to 0.10 to 2.0 mm and the array pitches of the image elements of the light collecting element 111a and through-holes 121a and 221a (light image elements 131a and 231a) are set to 0.11 to 2.2 mm, it is preferable that the thickness d is set to 0.10 to 20 mm, more preferably 0.40 to 10 mm.

Also, the explanation was directed to the case in which the through-hole patterns 121 and 221 are formed on the entire surface of the through-hole filters 12 and 22, but they can be formed on one portion.

In addition, the explanation was directed to the case in which a light irradiation device 15, etc., uses artificial light for forming the light image elements 131a and 231a, but the light can be natural light.

The sizes and the array pitches of the light collecting elements 111a and the through-holes 121a and 221a (light image elements 131a and 231a) shown in the attached drawings are drawn largely for emphasis and the convenience of explanation. In reality, extremely small light collecting elements 111a and through-holes 121a and 221a (light image elements 131a and 231a) are two-dimensionally arranged in large numbers.

While embodiments of the present invention were explained herein with reference to the attached drawings, such examples are not intended to limit the present invention to preferred embodiments described herein and/or illustrated herein. The present invention may be embodied in various modified and variable forms of the illustrated embodiments within the same or equivalent scope of the present invention.

1. An ornamental display comprising:
a sheet-like or plate-like transparent material having a surface on which a light collecting element pattern is formed, wherein the light collecting element pattern is formed by a plurality of convex lens-shaped light collecting elements arranged two-dimensionally at a predetermined array pitch with a directional arrangement of the light collecting elements; and
a through-hole filter made of a sheet-like or plate-like light blocking light blocking material having a through-hole pattern, wherein the through-hole pattern is formed by a plurality of through-holes arranged two-dimensionally with the same directional arrangement as the directional arrangement of the light collecting element pattern at an array pitch different from the array pitch of the light collecting elements,
wherein the transparent material and the through-hole filter are arranged in a manner such that the light collecting element pattern and the through-hole pattern face each other with a predetermined distance therebetween.

2. The ornamental display as recited in claim 1, wherein the through-hole filter is set to 30% or less in light transmission rate of the light blocking light blocking material.

3. The ornamental display as recited in claim 1, wherein the through-hole filter is adhered to a back surface of the transparent material.

4. The ornamental display as recited in claim 1, wherein the through-hole filter is adhered to a front surface or a back surface of a second transparent material arranged so as to face the transparent material with a predetermined distance therefrom.

5. The ornamental display as recited in claim 1, wherein a transparent color filter colored with a predetermined color is arranged so as to face the through-hole filter.

6. The ornamental display as recited in claim 1, wherein a light irradiation light irradiation device for irradiating artificial light against the through-hole filter is provided.
